(19) United States
(12) Patent Application Publication
(10) Pub. No.: US 2010/0257044 A1
(43) Pub. Date: Oct. 7, 2010

(54) PROVIDING DIGITAL CONTENT TO BUYERS

(76) Inventors: Mark DIAMOND, Montreal (CA); Wendy WISEMAN, Montreal (CA)

Correspondence Address: OGILVY RENAULT LLP, 1, Place Ville Marie, SUITE 2500, MONTREAL, QC, H3B 1R1, CA

(21) Appl. No.: 12/723,030

(22) Filed: Mar. 12, 2010

Related U.S. Application Data
(60) Provisional application No. 61/159,494, filed on Mar. 12, 2009.

(51) Int. Cl. G06Q 30/00; G06Q 50/00; G06Q 20/00; G06Q 99/00; G06F 17/30

(52) U.S. Cl. 705/14.23; 707/803; 707/E17.005

(57) ABSTRACT

There is described a way to incite users to purchase various forms of digital content instead of obtaining it illegally. This is done by bundling digital content with other goods/services such that the result of purchasing digital content is that additional goods/services are also acquired that would not have been acquired if the digital content had been obtained illegally.

### CROSS-REFERENCE TO RELATED APPLICATIONS

Misapplication claims priority under 35 USC 119(e) of U.S. Provisional Patent Application No. 61/159,494, filed on Mar. 12, 2009, the contents of which are hereby incorporated by reference.

### TECHNICAL FIELD

The present invention relates to the field of online purchase of digital content, and more specifically, to inciting digital content users to pay for obtaining the digital content instead of obtaining it by illegal means.

### BACKGROUND OF THE INVENTION

There are many products now available in digital form. Digital content typically refers to music, information and images that are available for download or distribution on electronic media. One area that has suffered quite a bit with the advent of the Internet is music downloads. A music download refers to the transferring of a music file from an Internet-facing computer or website to a user's local computer. This term encompasses both legal downloads and downloads of copyright material without permission or payment if required.

While digital music singles and albums are available online for a small fee, via sources such as the iTunes Store™, Napster™, and Nimbit™, the temptation to obtain copyrighted material illegally, i.e. without payment, is very high. Copies of legally and illegally obtained music files are easily available for others to use without having to purchase a new copy.

The industry has attempted to curb the trend of illegally copying music files by various means, such as selling self-eroding versions of music files, encrypting music files with special keys, and disseminating music files that cannot be copied. However, savvy and determined individuals continually find ways to circumvent new obstacles placed in the way of those that would like to illegally obtain copyrighted material.

### SUMMARY OF THE INVENTION

Therefore, there is provided herewith a way to incite users to purchase various forms of digital content instead of obtaining it illegally. This is done by bundling digital content with other goods/services such that the result of purchasing digital content is that additional goods/services are also acquired that would not have been acquired if the digital content had been obtained illegally.

In accordance with a first broad aspect, there is provided a method for providing digital content to a buyer, the method comprising: storing the digital content to be offered for purchase; storing a set of purchase incentives from an incentive supplier, each purchase incentive being associated with at least one item of the digital content and redeemable at the incentive supplier for goods or services for the buyer; and using a processor to perform the steps of: receiving a request to purchase one item of the digital content, the request comprising identification of the item and identification of the buyer; creating a file comprising: the item of digital content; one of the purchase incentives; the identification of the buyer; and an identification of a specific transaction; transmitting the file to the buyer.

In accordance with a second broad aspect, there is provided a system for providing digital content to a buyer, the system comprising: a purchase incentive database comprising a set of purchase incentives from an incentive supplier, each purchase incentive being associated with at least one item of the digital content and redeemable at the incentive supplier for goods or services for the buyer; a digital content data base comprising the digital content to be offered for purchase; a purchase request module adapted to receive a request to purchase the proprietary intellectual property, the request comprising identification of the item and identification of the buyer; a file creation module enabled by the purchase request module when a request for purchase has been received and adapted to create a file comprising: the item of digital content; one of the purchase incentives; the identification of the buyer; and an identification of a specific transaction; and a transaction module adapted to perform the specific transaction by transmitting the file to the buyer and receiving payment therefor.

In accordance with a third broad aspect, there is provided a system for providing digital content to a buyer, the system comprising: a processor in a computer system; a purchase incentive database accessible by the processor and comprising a set of purchase incentives from an incentive supplier, each purchase incentive being associated with at least one item of the digital content and redeemable at the incentive supplier for goods or services for the buyer; a digital content data base accessible by the processor and comprising the digital content to be offered for purchase; an application coupled to the processor, the application configured for: receiving a request to purchase one item of the digital content, the request comprising identification of the item and identification of the buyer; creating a file comprising: the item of digital content; one of the purchase incentives; the identification of the buyer; and an identification of a specific transaction; transmitting the file to the buyer.

In this specification, the term “digital content” is intended to mean any content in a digital format, including but not limited to music, videos, photos, art, movies, ring tones, and books. The term “incentives” is intended to refer to any added value for the purchaser, such as but not limited to discounts, rebates, cash, special rates, points, rewards, special accesses, backstage passes, and tickets.

For the purpose of the present description, the term “processor” is to be understood as a device that can perform operations on data. Examples are a central processing unit (CPU) and a front-end processor. For instance, a CPU directs data and instructions to and from other devices in the computer system, like the computer's memory and input devices. It also interprets programs. The term “database” is to be understood as a collection of data stored on a computer storage medium in a common pool for access on an as-needed basis. It can be a simple text file or a spread sheet, or have a more complex structure arranged from simplicity of searching and retrieving items.

### BRIEF DESCRIPTION OF THE DRAWINGS

Further features and advantages of the present invention will become apparent from the following detailed description, taken in combination with the appended drawings, in which:

FIG. 1 is a flowchart illustrating one embodiment of a method for providing digital content to a buyer;

FIG. 2 is a block diagram illustrating an embodiment of a system for providing digital content to a buyer using a processor; and

FIG. 3 is a block diagram illustrating another embodiment of a system for providing digital content to a buyer.

It will be noted that throughout the appended drawings, like features are identified by like reference numerals.

### DETAILED DESCRIPTION

There is described herein a method and system for inciting digital content users to purchase digital content instead of obtaining it illegally. Incentives are bundled together with digital content and offered as a package to the buyer. For example, a Rihanna song is offered with a 10% discount for a pair of jeans at The Gap™. Another example is a Rolling Stones song is offered with a free cup of coffee at Starbucks™. Various embodiments of the method and system will become apparent from the description below.

One of the different entities involved in the method and system described herein is the buyer, who purchases a variety of digital content, ranging from music and videos to art and financial information. The buyer has many ways of purchasing the digital content, such as by downloading files, online ordering, in stores, and others. Another entity involved is the digital content seller, which can be a record producer, a record label, an artist, or any individual who owns proprietary content and would like to offer it for a fee. A content seller wants to protect his rights as owner of the digital content and achieve his revenue and profit objectives from the sale of his digital content. A third entity involved is an incentive supplier, which can be a retailer such as The Gap™, a manufacturer such as Dell™, a service provider such as a dry-cleaner, a coffee house such as Starbucks™, or any other goods or services provider looking for customers. The incentive supplier leverages the efforts of the content seller by having the content seller bundle incentives with digital content to entice the buyer to purchase from the incentive supplier. The content seller leverages the draw of the incentive supplier's offer to entice the buyer to purchase the digital content. An enabler may be present, separate from the content seller, to provide the service that enables the bundled content and incentives to be packaged together in a given form. The enabler can be someone who sells the digital content on behalf of the content seller, or can be someone who bundles the incentives with the digital content and provides it to the content seller, who turns around and offers the bundled goods to the buyer. Alternatively, the content seller acts as the enabler by packaging the digital content with the purchase incentives and presenting the bundled goods to the buyer.

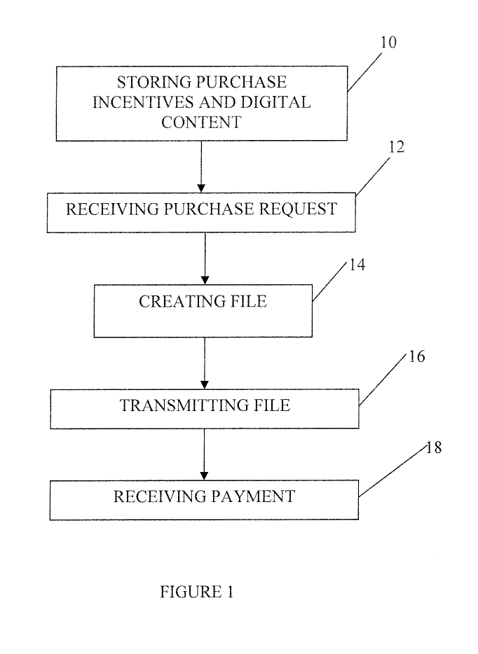

FIG. 1 illustrates one embodiment of the method of providing proprietary digital content to a buyer. In one embodiment, this method is performed by the enabler. In an alternative embodiment, the method is performed by the content seller. In yet another embodiment, the method is performed by the incentive supplier. Purchase incentives are stored and digital content items are stored 10. At least one purchase incentive is associated with a transaction for at least one item of digital content and redeemable at the incentive supplier for goods or services for the buyer. These purchase incentives are matched with given digital content and offered to buyers as a package. A purchase request is then received 12. The purchase request includes identification of the content for purchase as well as identification of the buyer. The purchase request causes a file to be created 14. The file may comprise various items, such as the content being purchased, the purchase incentive associated with that digital content, identification of the buyer, and a transaction ID. The file is then transmitted to the buyer 16 in exchange for a fee 18.

When associating a given digital content item with a given incentive, this may be done in various manners. In one embodiment, the incentive supplier is offered to bundle his goods/services with predetermined digital content. For example, The Gap™ is offered fifty Rihanna songs and asked for a discount to match each song. In another embodiment, the incentive supplier asks for a given digital content to be matched with predetermined goods/services. For example, The Gap™ asks that fifty 10% discounts for jeans be matched with fifty copies of a specific Rihanna song. In another embodiment, multiple digital content items are advertised to multiple incentive suppliers and the incentive suppliers can choose which digital content they would like their purchase incentives packaged with. In yet another embodiment, the purchase suppliers offer multiple purchase incentives and the content sellers can choose which purchase incentive they would like their digital content packaged with.

Selection of digital content and purchase incentives may be done arbitrarily or in a targeted manner. Targeted bundling of digital content and purchase incentives takes into account a given buyer's profile to select a purchase incentive that is more suited for a buyer of a given digital content. For example, a buyer of a Hannah Montana song has a profile that would fit with a young, female buyer, probably between 8 and 12 years old. A purchase incentive suitable for this profile, such as a free ticket to see a new Disney movie, would be bundled with a Hannah Montana song.

In one embodiment, the purchase incentive is related to the digital content with which it is packaged. For example, a Hannah Montana song is packaged with a rebate for Hanna Montana concert tickets. In another example, a Jonas Brothers song is packaged with a discount for Jonas Brothers paraphernalia, such as a Jonas Brothers backpack or t-shirt.

In one embodiment, at the time of purchase of digital content by the buyer, the purchase incentive is already packaged with the digital content. In another embodiment, the buyer may choose one (or more) purchase incentives from a plurality of purchase incentives offered. Selecting one from a plurality of purchase incentives creates a certain profile for the buyer, which may be used at a later point in time when the buyer returns for a subsequent purchase. Alternatively, the buyer's taste may be used to profile other buyers who purchase the same digital content.

In one embodiment, the purchase incentive is tracked to determine whether or not it is redeemed. For example, if the purchase incentive is a free cup of coffee at Starbucks™ and the buyer uses the coupon to obtain the free cup of coffee, this information is transmitted back to either the enabler, the content seller, and/or the incentive supplier. This may be done by providing the transaction ID at the point of purchase, namely the Starbucks™ store, at the time the coupon is redeemed. The transaction ID may be a barcode which is read by a barcode reader at the point of purchase and transmitted electronically via the Internet to a server, accessible by the enabler/content seller/incentive supplier, or it may be another type of code entered electronically via a system such that the information is sent to the server.

In one embodiment, the information is sent in real-time and the enabler/content seller/incentive supplier is able to immediately know that the purchase incentive has been redeemed for the goods/services for which it was meant. In another embodiment, the information is sent at a later point in time, such as the end of a business day or business week, or at any other frequency deemed appropriate. A device may be provided at the point of purchase to allow the information to be sent, or it may simply be sent via an Internet connection on a computer already present at the point of purchase.

In one embodiment, redeeming a purchase incentive can lead to other benefits for the buyer. For example, the buyer, which is known from the buyer ID provided during the initial transaction, may be offered other purchase incentives that are not offered to other buyers the next time he is looking to purchase digital content. In another example, the buyer may be offered another purchase incentive in real time, via an email, a text message, or any other type of electronic communication that can reach the buyer in real time, such as directly at the point of purchase at the cash register when the initial purchase incentive is being redeemed. If the buyer has provided an email address, a cell phone number, or any other addressing means, the enabler/content seller/incentive supplier may choose to reward the buyer immediately after redeeming the initial purchase incentive by providing a secondary purchase incentive. Alternatively, the buyer may be rewarded at a later point in time, such as when a subsequent transaction occurs for new digital content, or by receiving a new purchase incentive by regular mail.

In one embodiment, the secondary purchase incentive is redeemable for a fixed amount of time, such as in the next 10 minutes, the next hour, the next day, or any other time period deemed appropriate. In one embodiment, the secondary purchase incentive is also chosen to fit the profile of the buyer. In another embodiment, the secondary purchase incentive is chosen geographically as a function of where the initial purchase incentive was redeemed. For example, if the Starbucks™ coffee was obtained at the corner of Lexington Avenue and 78^{th} street in New York city, then a free facial at a beauty salon just up the street may be offered as a secondary purchase incentive. This offer may be time independent, or may be valid only for the next 30 minutes. Additional purchase incentives may be offered every time a previous purchase incentive is redeemed.

In one embodiment, the location of the secondary (or subsequent) purchase incentive point of sale is provided via Google Maps™ on the buyer's mobile, blackberry, portable computer or other type of personal digital assistant (PDA). The enabler/content seller/incentive supplier can track the buyer's location either by using satellite technology with PDA or cell phone information, or by identifying the location of a point of sale for a redeemed purchase incentive.

In one embodiment, a single purchase using a purchase incentive will trigger a series of events with a list of goods/services. The purchase incentives may increase in value when it is deemed that the buyer is a “good buyer” and the transactions are recurring. Recurring transactions may mean recurring purchases of digital content packaged with purchase incentives, or recurring redeeming of purchase incentives.

Identification of the buyer may be done at the time of purchase of the digital content by asking the buyer to register on a website, thereby obtaining various information about the buyer, such as name, home address, telephone number, email address, mobile number, etc. A buyer account may be created for a given buyer and reused for subsequent purchases. The buyer account may be password protected to ensure that other buyers do not usurp a buyer's identity and take advantage of gains obtained by the buyer from past purchase incentives and/or transactions. Alternatively, the buyer ID is a single identification item, such as a username and password or an email address, and is used to identify the buyer in the system. The same buyer ID may be used when the buyer redeems the purchase incentive at a point of purchase, to verify his identity.

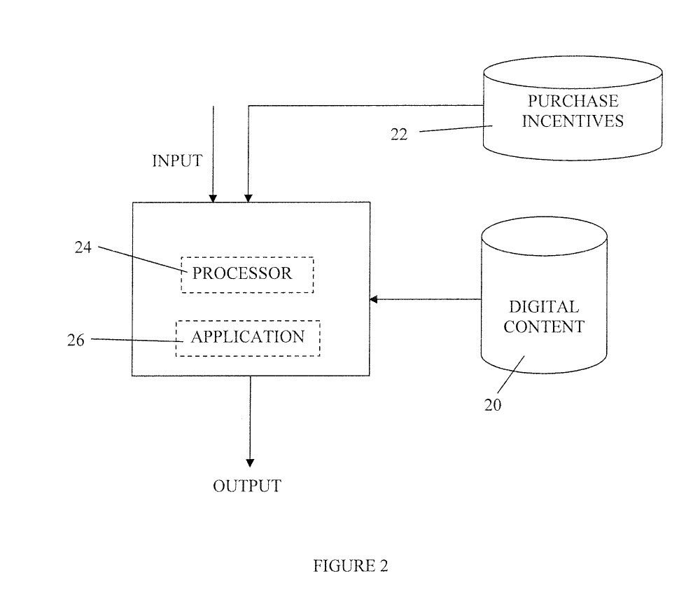

FIG. 2 illustrates an embodiment of a system for providing digital content to a buyer. A processor 24 is in a computer system. A purchase incentive database 22 accessible by the processor stores a set of purchase incentives from an incentive supplier, each purchase incentive being associated with at least one item of the digital content and redeemable at the incentive supplier for goods or services for the buyer. A digital content database 20 accessible by the processor stores the digital content to be offered for purchase. An application 26 coupled to the processor is configured for: receiving a request to purchase one item of the digital content, the request comprising identification of the item and identification of the buyer; creating a file, and transmitting said file to the buyer.

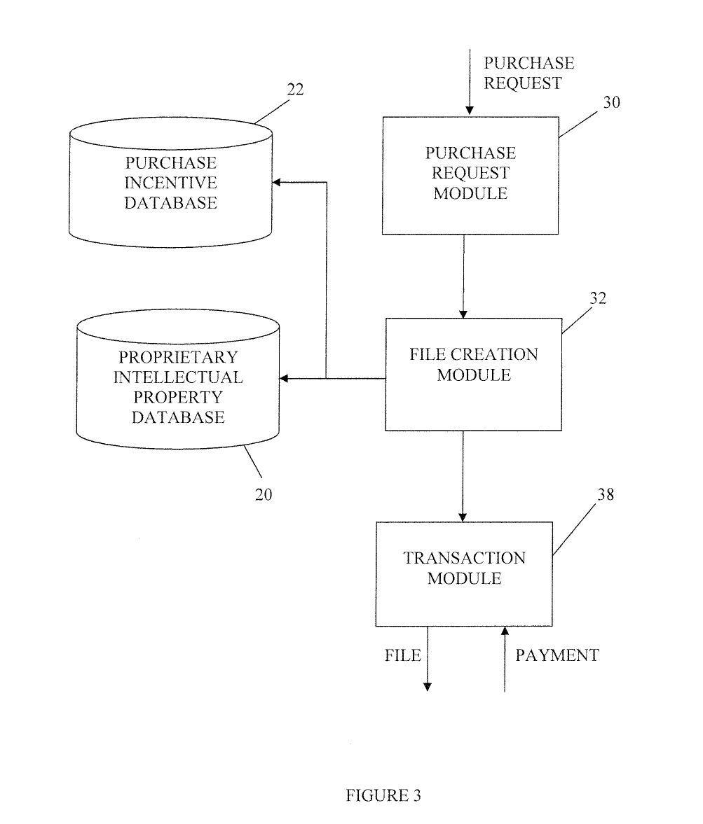

FIG. 3 illustrates another embodiment of a system for providing proprietary digital content to a buyer. A purchase request module 30 receives the purchase request. This triggers the file creation module 32 to create a packaged digital content/purchase incentive file. The file creation module 32 accesses the purchase incentive database 22 and the digital content database 20 to create the file. The file is then sent to the transaction module 38 where the file is sent in exchange of payment.

The file may be in a variety of different forms, such as having the digital content and the purchase incentive embedded together or provided separately. If embedded together, the two must be separated from each other after download to allow the buyer to access both the digital content and the purchase incentive. Alternatively, the file may be multiple files zipped together (or joined in any other way, such as compressed and archived files), one file containing the digital content and another file containing the purchase incentive. A transaction ID may also be provided to identify the transaction at the point of purchase in addition to providing the purchase incentive. The transaction ID can be used as an additional security means to ensure that the buyer is actually the one who redeems the purchase incentive. The transaction ID may be embedded or encoded in the purchase incentive or may be provided separately.

The purchase incentive may be in the form of a coupon printable on paper such that it can be redeemed. Alternatively, it may be transmitted electronically to another device at the point of purchase via infrared or other wireless transmission means. For example, a device meant to receive an electronic file with the purchase incentive may be present at the point of purchase.

The digital content may be in various file formats, such as for example uncompressed multimedia file formats such as WAV, RIFF and AU, or formats with lossless compression such as FLAC, APE, WV, Shorten, TAK, TTA, ATRAC Advanced Lossless, Apple Lossless and lossless Windows Media Audio (WMA). Other examples of audio formats are formats with lossy compression, such as MP3, Vorbis, Musepack, ATRAC, lossy Windows Media Audio (WMA) and AAC. Open file formats (gsm, dct, vox aac, mp4/m4a, and mmf) and proprietary file formats (mp3, wma, atrac, ra, ram, dss, msv, dvf, IVS, m4p, iklax, and mxp4) may also be used. Other examples of file formats are FITS, TIFF, 3GP, ASF, AVI, DVR-MS, DVR-MS, IFF, MKV, MPEG-TS, MP4, MOV, Ogg, OGM, RealMedia, PDF, RTF, MS Word, Excel, PowerPoint and RealPlayer.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetic signal. The embodiments of the invention described above are intended to be exemplary only. The scope of the invention is therefore intended to be limited solely by the scope of the appended claims.

I/We claim:

1. A method for providing digital content to a buyer, the method comprising:
storing said digital content to be offered for purchase;
storing a set of purchase incentives from an incentive supplier, each purchase incentive being associated with at least one item of said digital content and redeemable at said incentive supplier for goods or services for said buyer; and
using a processor to perform the steps of:
receiving a request to purchase one item of said digital content, said request comprising identification of said item and identification of said buyer;
creating a file comprising:
said item of digital content;
one of said purchase incentives;
said identification of said buyer; and
an identification of a specific transaction;
transmitting said file to said buyer.

2. A system for providing digital content to a buyer, the system comprising:
a purchase incentive database comprising a set of purchase incentives from an incentive supplier, each purchase incentive being associated with at least one item of said digital content and redeemable at said incentive supplier for goods or services for said buyer;
a digital content data base comprising said digital content to be offered for purchase;
a purchase request module adapted to receive a request to purchase said proprietary intellectual property, said request comprising identification of said item and identification of said buyer;
a file creation module enabled by said purchase request module when a request for purchase has been received and adapted to create a file comprising:
said item of digital content;
one of said purchase incentives;
said identification of said buyer; and
an identification of a specific transaction; and
a transaction module adapted to perform said specific transaction by transmitting said file to said buyer and receiving payment therefor.

3. A system for providing digital content to a buyer, the system comprising:
a processor in a computer system;
a purchase incentive database accessible by the processor and comprising a set of purchase incentives from an incentive supplier, each purchase incentive being associated with at least one item of said digital content and redeemable at said incentive supplier for goods or services for said buyer;
a digital content data base accessible by the processor and comprising said digital content to be offered for purchase;
an application coupled to the processor, the application configured for:
receiving a request to purchase one item of said digital content, said request comprising identification of said item and identification of said buyer;
creating a file comprising:
said item of digital content;
one of said purchase incentives;
said identification of said buyer; and
an identification of a specific transaction;
transmitting said file to said buyer.
